(19) United States
(12) Patent Application Publication
(10) Pub. No.: US 2026/0106821 A1
(43) Pub. Date: Apr. 16, 2026

(54) Sparse Route Computation for Determining Optical Paths with Defined Optical Regenerator Locations

(71) Applicant: Ciena Corporation, Hanover, MD (US)

(72) Inventors: Seemant Bisht, New Delhi (IN); Anikash Chaudhary, Gurgaon (IN); Dominic Richens, Perth (CA); Mohit Chhillar, Gurugram (IN)

(73) Assignee: Ciena Corporation, Hanover, MD (US)

(21) Appl. No.: 19/006,463

(22) Filed: Dec. 31, 2024

(30) Foreign Application Priority Data
Oct. 16, 2024 (IN) 202411078573

(51) Int. Cl. H04L 45/122; H04B 10/27

(52) U.S. Cl. CPC H04L 45/122; H04B 10/27

(57) ABSTRACT

Systems and methods for a sparse route computation for determining optical paths with defined optical regenerator locations in an optical network include receiving a request to compute one or more paths from a source node to a destination node with one or more regen nodes in an optical network; utilizing the one or more regen nodes as an inclusion hops list; and performing a Shortest Path First (SPF) computation with the inclusion hops list to find the one or more paths with tentative (tent) paths maintained in a tent list and further utilizing a discourage factor in minimal route diversity to order the tent paths in the tent list based on the inclusion hops list.

### FIELD OF THE DISCLOSURE

The present disclosure relates generally to optical networking. More particularly, the present disclosure relates to systems and methods for a sparse route computation for determining optical paths with defined optical regenerator locations in an optical network.

### BACKGROUND OF THE DISCLOSURE

An optical network is a communication system that transmits data via light through optical fibers, offering high bandwidth and low signal attenuation over long distances. In large optical networks, as the light signal travels, it experiences degradation due to factors like attenuation, dispersion, and nonlinear effects, which can impair data integrity. To counteract this, regenerators are employed at specific intervals to restore the optical signal to its original quality. The placement of these regenerators—known as regen locations—is determined by analyzing the maximum distance the signal can travel before falling below acceptable performance thresholds. This analysis considers the characteristics of the optical fiber, the quality of the transmission equipment, network topology, and the cumulative effects of signal degradation. By strategically locating regenerators, network designers ensure reliable data transmission across extensive optical infrastructures. In situations where regen locations are fixed or defined, conventional path computation techniques tend to be expensive (in terms of compute power and time), do not guarantee correct results (e.g., shortest paths, correct order of regens, etc.), and require the user to explicitly configure paths.

### BRIEF SUMMARY OF THE DISCLOSURE

The present disclosure relates to systems and methods for a sparse route computation for determining paths with defined optical regenerator locations in an optical network. Sparse route computation in optical networks refers to the process of determining the most efficient paths in a network with limited connectivity, where fewer nodes or links are available for routing. Again, existing approaches for path computation with fixed regen placement are expensive (in terms of compute power and time), do not guarantee correct results (e.g., shortest paths), and require the user to explicitly configure paths. For example, for the user to explicitly configure paths, the user needs to consider all possible combinations of Designated Transit Lists (DTLs) via regens which is difficult in larger networks. Accordingly, the present disclosure includes implicit computation of paths via provided regen nodes in a defined order with a sparse route completion algorithm using minimal route diversity (minRD) constraint. This approach is faster in computation and yields better results than existing techniques.

In various embodiments, the present disclosure includes a method having steps, an apparatus configured to implement the steps, and a non-transitory computer-readable medium storing instructions that, when executed, cause one or more processors to implement the steps. The apparatus can be a network element in an optical network, a processing device, etc. The steps include receiving a request to compute one or more paths from a source node to a destination node with one or more regen nodes in an optical network; utilizing the one or more regen nodes as an inclusion hops list; and performing a Shortest Path First (SPF) computation with the inclusion hops list to find the one or more paths with tentative (tent) paths maintained in a tent list and further utilizing a discourage factor in minimal route diversity to order the tent paths in the tent list based on the inclusion hops list. The inclusion hops list includes the one or more regen nodes in a defined order such that the SPF computation provides the one or more paths with the one or more regen nodes in the defined order. The discourage factor is used to increase cost of all links except those in the inclusion hops list, thereby placing such links in the inclusion hops list at a top of the tent list. The SPF computation can be a k-SPF computation to obtain k paths, k>1, for the one or more paths. The performing the SPF computation can further include allocating spectrum between the source node, the one or more regen nodes, and the destination node. The spectrum allocation can include a change in spectrum along a path.

### BRIEF DESCRIPTION OF THE DRAWINGS

The present disclosure is detailed through various drawings, where like components or steps are indicated by identical reference numbers for clarity and consistency.

FIG. 1 illustrates an example optical network for illustrating path computation with regens.

FIG. 2 illustrates the example optical network of FIG. 1 for illustrating path computation with a regen at the node for a path between the nodes using existing approaches.

FIG. 3 illustrates the example optical network of FIG. 1 for illustrating path computation with a regen at the node for a path between the nodes using sparse route completion via inclusion hops list.

FIGS. 4 and 5 illustrate graphs of time taken to compute routes with and without the cost discourage factor, to show improvement with the approach described herein.

FIG. 6 illustrates the example network of FIG. 1 to show spectrum allocation on a per regen segment.

FIG. 7 illustrates a block diagram of a network element, depicted in a simplified functional format.

FIG. 8 illustrates a block diagram of an example processing device.

FIG. 9 illustrates a flowchart of a process for sparse route computation for determining optical regenerator locations in an optical network.

### DETAILED DESCRIPTION OF THE DISCLOSURE

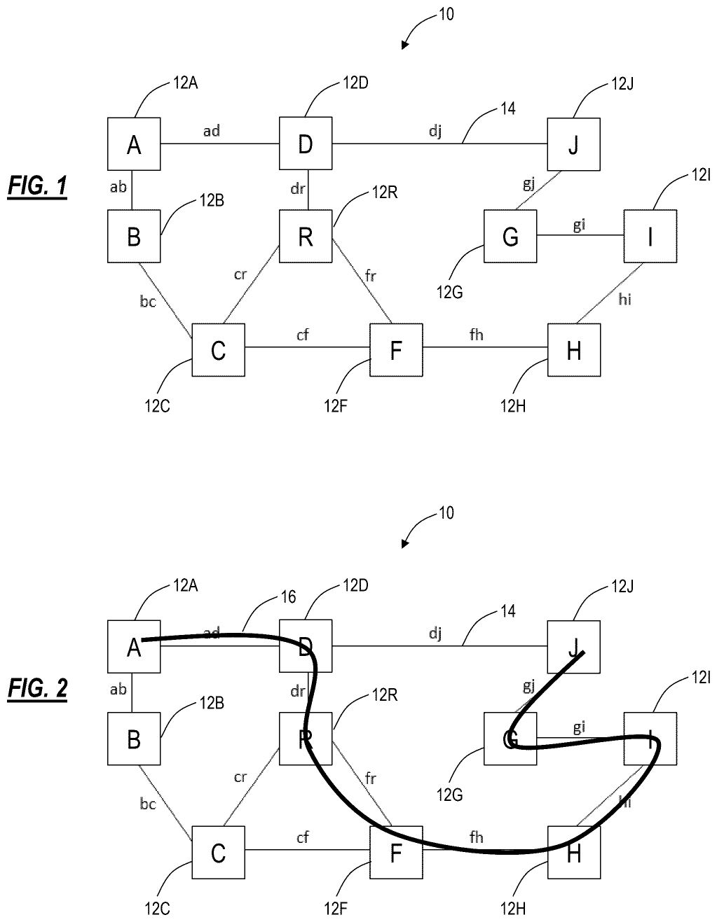

Again, the present disclosure relates to systems and methods for a sparse route computation for determining optical paths with defined regenerator locations in an optical network. Of note, the regen locations are fixed or defined meaning they are input to any path computation and any returning path must include these locations between the source and destination. FIG. 1 illustrates an example optical network 10 for illustrating path computation with regens. The optical network 10 can also be referred to as a photonic network and includes nodes 12, labeled nodes 12A-12J interconnected to one another via links 14 (labeled XY where X, Y refer to the associated nodes 12). The nodes 12 can also be referred to as network elements and include various equipment to support optical connectivity. For example, the nodes 12 can be terminals, routers, switches, Reconfigurable Optical Add/Drop Multiplexers (ROADMs), and the like. The node 12 is a device or point where optical signals are processed, regenerated, switched, or routed to ensure proper data transmission across the optical network 10. It serves as a critical junction that manages the flow of optical data between connected fiber links 14 and other nodes 12. The links 14 are fiber cables, supporting bidirectional communication between two nodes, e.g., typical deployments include two fibers for each link 14 with each fiber supporting unidirectional transmission between the nodes 12.

Those skilled in the art will recognize the optical network 10 is simplified in terms of number of nodes 12 and links 14 for illustration purposes and typical network deployments could have significantly more nodes 12 and links 14, thereby exacerbating the path computation complexity with regens. As well, there can be multiple fibers in any given link 14 between two nodes 12, i.e., FIG. 1 is a logical view. Path computation can consider each fiber or fiber pair individually, e.g., in parallel rails, further exacerbating the complexity in path computation. Again, in the optical network 10, regeneration is essential to maintain signal quality in specific scenarios. For long-haul transmission, signals degrade over vast distances due to attenuation, dispersion, and noise, necessitating regeneration at intermediate points to restore their integrity. Additionally, in complex network architectures with multiple nodes 12, signals can suffer from loss and distortion, requiring regeneration to ensure reliable transmission. A regenerator is essentially a node 12 in the optical network 10 where optical signals are optically received and converted to electrical signals and back to optical signals, so-called optical-electrical-optical (OEO) regeneration. Conversely, pass-through nodes 12 are ones where optical signals enter the node 12 optically and are redirected out the node 12 optically as well. Further, those skilled in the art will understand the optical network 10 further includes intermediate line amplifier sites on the links 14 where optical amplifiers (e.g., Erbium Doped Fiber Amplifiers (EDFAs), Raman amplifiers, etc.) are used, and these are omitted for illustration purposes.

Further note, while some designs of optical networks 10 include extended reach, e.g., thousands of kilometers, another trend is increased bandwidth of each channel, i.e., higher baud rates and bit rates, which can lead to less reach. Thus, there is always a need for some regenerators in larger optical networks 10. For example, optical channels of 800 G, 1.6 T, etc. may have distance limitations of 700-900 km.

Path computation in the optical network 10 with Designated Transit Lists (DTLs) involves the calculation of a path while meeting certain constraints. A DTL specifies a predefined sequence of the nodes 12 and associated links 14 from the source to the destination. This allows for more granular control over the path, ensuring that specific nodes 12 or links 14 are used or avoided based on network policies, performance requirements, or fault tolerance strategies. A Path Computation Element (PCE) in the optical network 10 utilizes algorithms to determine the path, taking into account factors like available bandwidth, signal quality, and potential congestion. By enforcing the use of certain nodes 12, DTLs enable operators to maintain better control over traffic distribution, optimize resource utilization, and enhance overall network performance and reliability.

Managing DTLs with large numbers of nodes and regeneration points presents several challenges. As the number of nodes 12 increases, the complexity of path computation also grows exponentially, making it harder to calculate optimal routes that meet specific constraints. Additionally, including regeneration (regen) points further complicates the process because the network 10 must account for both optical impairments and available resources at these regen nodes 12. Each regen point needs to restore the signal, potentially requiring more resources and making it difficult to dynamically allocate them as demand changes. The coordination between multiple nodes 12, including regens, can lead to scalability issues, increased latency in path setup, and greater difficulty in maintaining efficiency while adhering to the DTL constraints. This complexity can result in inefficiencies, such as underutilization of network resources or delays in path computation, especially in as the number of nodes 12 and links 14 scale.

FIG. 2 illustrates the example optical network 10 for illustrating path computation with a regen at the node 12R for a path between the nodes 12A, 12J using existing approaches. Of note, the path is specified as between the nodes 12A, 12J, with a regen designated at the node 12R. With existing techniques, the path computation will find the shortest path between each hops to complete a whole sparse route 16. Note, the terms path and route are used interchangeably herein. The algorithm will return the route 16 between nodes 12 (A-D-R-F-H-I-G-J) by finding the shortest path between the nodes 12A, 12R, i.e. A-D-R, and then between nodes 12R, 12J, i.e., R-F-H-I-G-J, which is not the shortest path between the nodes 12A, 12J, via the regen node 12R, as is clearly visualized in FIG. 2.

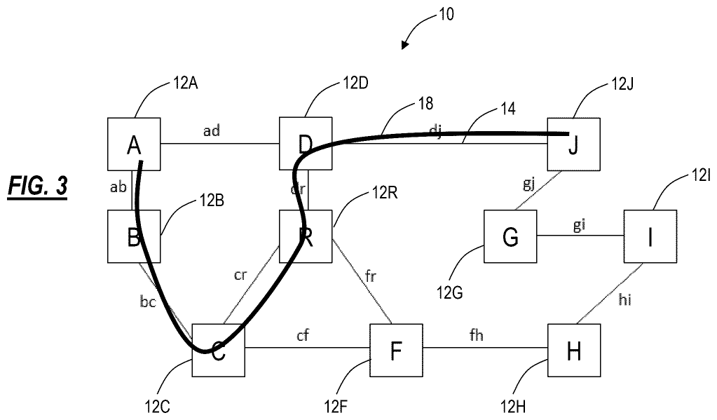

FIG. 3 illustrates the example optical network 10 for illustrating path computation with a regen at the node 12R for a path between the nodes 12A, 12J using sparse route completion via inclusion hops list. Sparse route completion via inclusion hops list is a technique used in path computation where a partial route is extended or completed by incorporating specific nodes (hops) into the path. In sparse or incomplete routes, not all nodes or links between the source and destination are explicitly defined. To address this, an inclusion hops list is provided, which contains key nodes, e.g., the node 12R, that the computed path must traverse. These designated hops guide the path calculation to ensure certain network points are included, helping to complete the route while still allowing flexibility in how intermediate links or nodes are chosen. This approach is particularly useful in large-scale or complex networks where it is impractical to specify every step of a route, but where certain critical nodes or network segments must be part of the path for performance, policy, or resiliency reasons. By combining sparse route information with inclusion hops, the network can efficiently compute an optimal path while satisfying specific constraints.

Here, the approach finds the shortest paths between the nodes 12A, 12J that goes via inclusion hops list in provided order, i.e., the node 12R. The algorithm guarantees the shortest path end to end. The PCE starts from the originating node 12A and applies K Shortest Path First (KSPF) to find the shortest path to the node 12J. The PCE keeps discarding any tentative path (partial path) that does not follow the order of provided inclusion hops. It also discards any route that reaches terminating node but does uses all the inclusion hops.

Now, this approach succeeds in finding the best route, e.g., nodes 12 (A-B-C-R-D-J), but there can be efficiencies to improve the speed of this approach. For example, there is a desire to perform the PCE functionality at the node 12, so-called on-box computation or in-situ computation (versus off-box where the path computation is performed in an external device or service). The goal in on-box computation is speed as these paths may be needed for restoration, e.g., computed responsive to a fault to find a new path immediately.

In an embodiment, the present disclosure includes implicit computation of paths via provided regen nodes in a defined order with the help of a sparse route completion algorithm using a minimal route diversity constraint. The minimal route diversity constraint for sparse route completion is a requirement that ensures a minimum level of diversity or differentiation between computed route and regen nodes in an inclusion list in the network 10. When calculating multiple paths between a source and destination, this constraint ensures that all the routes share the same provided regen nodes. as many common nodes or links as possible. In the context of sparse route completion, where only a subset of the path (a sparse route) is defined, the minimal route diversity constraint ensures that when completing the route, the newly calculated paths share the same nodes, i.e., regen locations, in the inclusion list.

In particular, the minimal route diversity constraint with the sparse route completion via inclusion hops list can be used to improve the path computation speed. In particular, the PCE applies minimal route diversity constraint with the inclusion hops list. to give priority to routes passing via inclusion nodes, i.e., the regens. The PCE discourages all the nodes 12 in network by factor N except of those in the inclusion hops list. This brings the partial paths up in traverse list to complete. In the example of the optical network 10, the end-to-end route computation between the nodes 12A, 12J with minimal route diversity (MinRD) approach makes sure that the computed route has the regen locations included. The proposed algorithm is to use this approach with ordered-set of inclusion-links constraint to make the search faster, giving priority to hops/nodes in an inclusion-list (which are regen nodes).

This approach is described with reference to the optical network. The PCE will be provided the source node 12A and the destination node 12J to calculate the paths along with an inclusion hops list (the regen node 12R). The PCE will start searching for a Shortest Path First (SPF) in a graph from node 12A will keep building a tentative (tent) list (list of partial valid paths). The tent list refers to a temporary or intermediate list of nodes and links that are being considered as part of a computed path. During the process of calculating the optimal route between a source and destination, algorithms such as Dijkstra's shortest path algorithm use a tent list to keep track of potential nodes and their associated costs or distances. As the PCE evaluates possible paths, it maintains a tent list to store candidate nodes that are tentatively selected for the final path but have not yet been confirmed. The list is updated as the algorithm progresses, comparing the costs of different routes. Once the path is finalized, nodes in the tent list either become part of the confirmed route or are discarded. The use of the tent list helps the algorithm efficiently explore multiple routing options while dynamically refining the best possible path based on network constraints like distance, bandwidth, or latency.

A tent path is one that is added to the tent list, and all tent paths must follow the strict rule of the inclusion hops list in the defined order. Any tent path not found to follow the order of hops in the inclusion hops list will be discarded. The PCE will apply MinRD to order the tent list while adding any new tent path to the list. To apply MinRD, the PCE will increase the link costs of all variable links (not in the inclusion hops list) in the network by a discourage factor. A discourage factor refers to a penalty or weight that is applied during path computation to speed up path selection that share common nodes with given list, namely the regen nodes and associated links or segments in this case. It is a mechanism used to enforce route diversity by making overlapping sections of a path less desirable compared to more independent routes. The present disclosure uses this discourage factor to bias tent paths to avoid those that do not follow the order of hops in the inclusion hops list. For example, the discourage factor can be some arbitrary large value, e.g., considering the above example, all links except of links “via the node 12R” will have cost increased by 0×100000. Because of increased cost of non-overlapping hops, tent paths with hops of the inclusion list will always be on top of tent list and will so make the search of shortest path to the destination faster.

The discourage factor is used in both minimal route diversity and maximum route diversity. Note, typically the use of a discourage factor in maximum route diversity ensures that the network has robust, fault-tolerant paths by reducing the risk of multiple paths failing due to a common node or link failure. It helps to balance the need for route diversity against other path selection criteria, such as performance or resource efficiency. In path computation, minimal route diversity and maximum route diversity algorithms address different objectives concerning the overlap of network elements—specifically nodes and links—used in routing paths. A minimal route diversity algorithm seeks to find multiple paths between a source and destination that share as many common nodes and links as possible. This means intentionally selecting routes that traverse the same network elements, which can be advantageous for policy compliance, security considerations, or simplified network management. Conversely, a maximum route diversity algorithm aims to compute multiple paths that are as disjoint as possible, minimizing the overlap of nodes and links between them. This approach enhances fault tolerance and reliability by ensuring that the failure of a single network element does not impact all available paths.

The discourage factor is a critical component used in both algorithms to influence the selection of routes based on the desired level of overlap or diversity among the paths. In the context of minimal route diversity, the discourage factor is applied to nodes and links that are not part of the previously selected paths. By assigning a higher cost or penalty to these unused network elements, the algorithm is discouraged from choosing routes that introduce new nodes or links. This encourages the selection of paths that reuse the same network elements, thereby maximizing overlap and meeting objectives like policy compliance or centralized security. In maximum route diversity algorithms, the discourage factor is used in the opposite manner. It is applied to nodes and links that have already been used in previously computed paths. By increasing the cost or penalty associated with these shared elements, the algorithm is discouraged from selecting routes that overlap with existing ones. This promotes the discovery of disjoint paths by making routes that share common nodes or links less attractive from a cost perspective. The discourage factor effectively steers the path computation towards maximizing diversity, enhancing the network's resilience against failures.

In particular with the present disclosure, the discourage factor is specifically applied to node and links associated with regens in the inclusion list. This ensures the algorithm is encouraged to select these nodes and links. That is, the present disclosure is using the discourage factor in a minimal route diversity approach to improve speed by biasing the tent paths that include the regen nodes in the proper order. That is, the discourage factor is used to bias paths that include the inclusion nodes, i.e., defined regen locations.

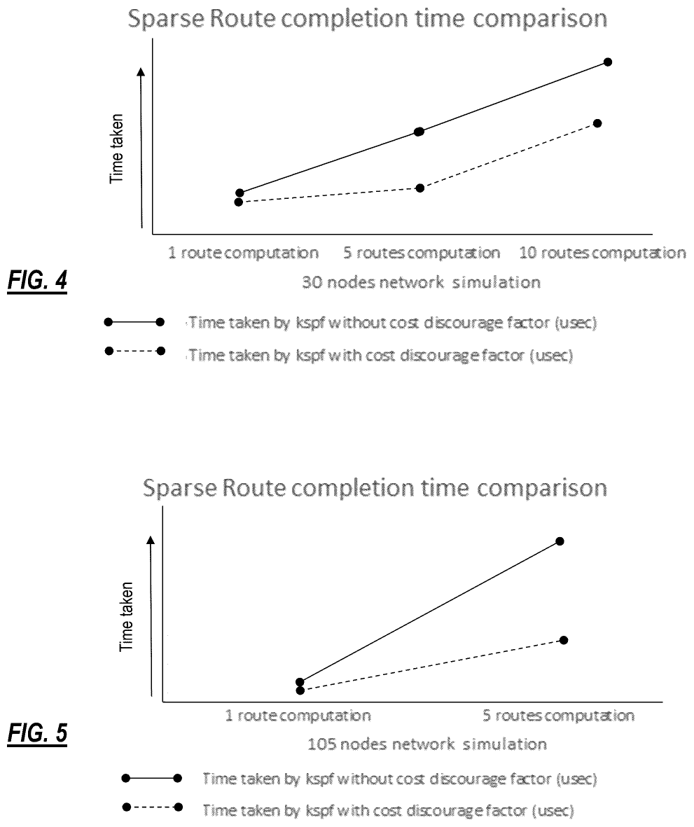

FIGS. 4 and 5 illustrate graphs of time taken to compute routes with and without the cost discourage factor, to show improvement with the approach described herein. In particular, FIG. 4 illustrates a network with 30 nodes, illustrating time taken to compute 1, 5, and 10 routes. FIG. 5 illustrates a network with 105 nodes, illustrating time taken to compute 1 and 5 routes. As clearly indicated in both, the use of the MinRD constraint improves times significantly, especially for more routes.

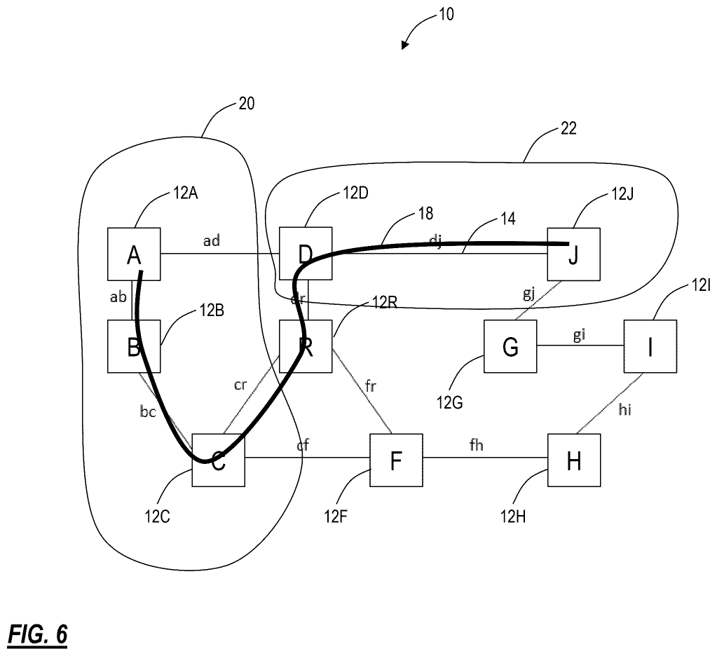

FIG. 6 illustrates the example network 10 to show spectrum allocation on a per regen segment. As the regen path is being computed with the inclusion hops list, spectrum allocation will also be done per regen segment. On hitting the first inclusion hop, consider a first segment 20 is found. The PCE will calculate the contiguous available spectrum on the corresponding segment and can start a fresh contiguous spectrum allocation for next segment 22 while building the tent path.

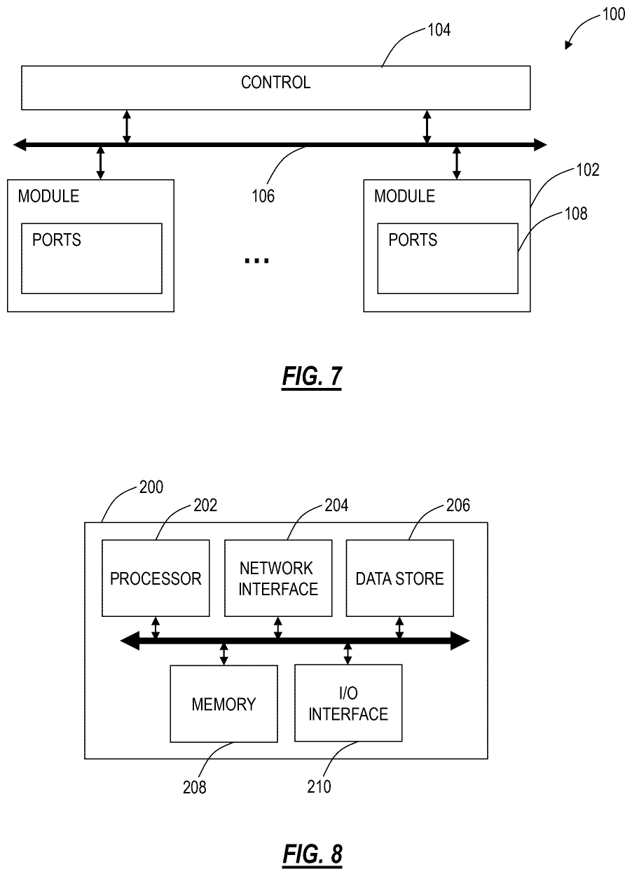

FIG. 7 illustrates a block diagram of a network element 100, depicted in a simplified functional format. It is important to note that a more practical design of this router would likely include additional components and processing logic to accommodate standard operating features, which are not detailed here. The network element 100 may represent any network element operable in the optical network 10, and includes various interconnected modules, such as modules 102 and 104, via an interface 106. These modules, also known as blades or line cards, are typically mounted on the chassis of a data switching device. Each module can house numerous electronic or optical devices on a circuit board, complete with various interconnects, including interfaces to the chassis itself.

Specifically, the diagram illustrates two types of modules: line modules 102, which feature multiple Ethernet ports for external connections, and a control module 104. The line modules facilitate data traffic switching between ports via a switching fabric, integrated across the modules, potentially centralized in a separate unit or module, as well as a combination. This switching fabric includes hardware, software, and firmware that routes incoming data to the appropriate port. The control module 104 is equipped with a microprocessor, memory, software, and a network interface to manage operations such as configuration and monitoring of the network element 100. It may also communicate with external network management systems or databases that handle provisioning and operational data.

Lastly, while FIG. 7 provides a basic view, those skilled in the art will understand that the network element 100 could include additional components or be configured differently, such as in a distributed arrangement or as an integrated, rack-mounted unit. This depiction in FIG. 7 is intended to convey functional aspects, with actual hardware implementations varying widely. In an embodiment, the PCE can be implemented via the control module 104.

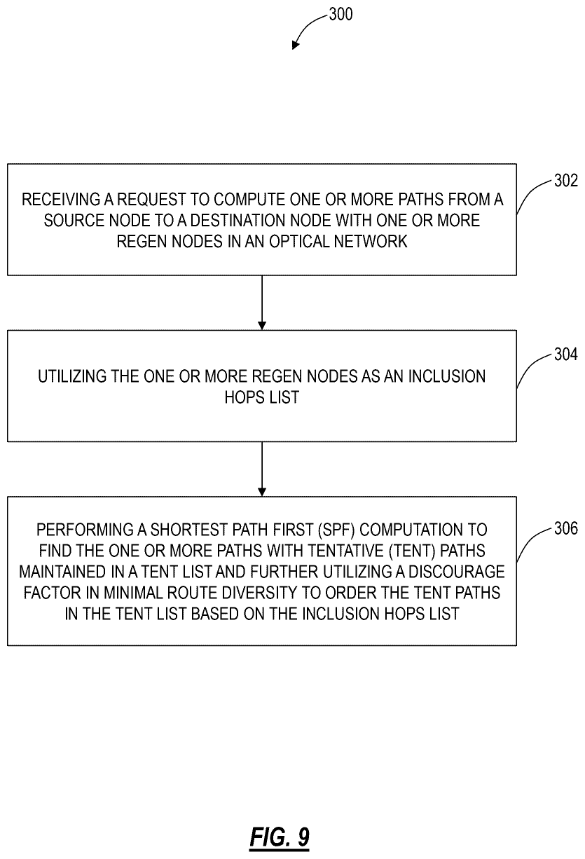

FIG. 8 illustrates a block diagram of an example processing device 200. The processing device 200 may be integrated within the network element 100 or function as a standalone unit connected to the network element 100. It may also be known as an apparatus, a control module, shelf controller, shelf processor, or system controller. The core of the processing device 200 is a processing unit 202, a hardware unit that runs software instructions. The processing unit 202 could be one or more custom or commercially available processors, i.e., one or more processors. During operation, the processing unit 202 executes software from memory, manages data communication with the memory, and controls the processing device 200 operations based on the software. In an embodiment, the PCE can be implemented via the processing device 200,

The processing device 200 also features several components connected to the processing unit 202: a network interface 204, a data store 206, memory 208, and an I/O interface 210. The network interface 204, possibly an Ethernet device, allows the processing device 200 to communicate over a data network and includes necessary connections for address, control, and data communication. The data store 206 stores various types of data such as telemetry data, Operations, Administration, Maintenance, and Provisioning (OAM&P) data, etc., and may include both volatile (e.g., RAM) and nonvolatile (e.g., ROM, hard drives) memory elements. Similarly, the memory 208 includes volatile and nonvolatile storage media, potentially employing a distributed architecture where components are located remotely but accessible by the processing unit 202. The I/O interface facilitates communication between processing device 200 and external devices.

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

FIG. 9 illustrates a flowchart of a process 300 for sparse route computation for determining optical regenerator locations in an optical network. The process 300 contemplates implementation as a method having steps, via an apparatus such as the processing device 200 or the control module 104 configured to implement the steps, and with a non-transitory computer-readable medium storing instructions that, when executed, cause one or more processors to implement the steps.

The steps include receiving a request to compute one or more paths from a source node to a destination node with one or more regen nodes in an optical network (step 302); utilizing the one or more regen nodes as an inclusion hops list (step 304); and performing a Shortest Path First (SPF) computation with the inclusion hops list to find the one or more paths with tentative (tent) paths maintained in a tent list and further utilizing a discourage factor in minimal route diversity to order the tent paths in the tent list based in the inclusion hops list (step 306).

The inclusion hops list includes the one or more regen nodes in a defined order such that the SPF computation provides the one or more paths with the one or more regen nodes in the defined order. The discourage factor is used to increase cost of all links except those in the inclusion hops list, thereby placing such links in the inclusion hops list at a top of the tent list. i.e., to increase the speed to a solution. The SPF computation can be a k-SPF computation to obtain k paths, k>1, for the one or more paths. The performing the SPF computation can further include allocating spectrum between the source node, the one or more regen nodes, and the destination node. The spectrum allocation can include a change in spectrum along a path.

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. An apparatus comprising:
one or more processors and memory storing instructions that, when executed, cause the one or more processors to
receive a request to compute one or more paths from a source node to a destination node with one or more regen nodes in an optical network,
utilize the one or more regen nodes as an inclusion hops list, and
perform a Shortest Path First (SPF) computation with the inclusion hops list to find the one or more paths with tentative (tent) paths maintained in a tent list and further utilizing a discourage factor in minimal route diversity to order the tent paths in the tent list based on the inclusion hops list.

2. The apparatus of claim 1, wherein the inclusion hops list includes the one or more regen nodes in a defined order such that the SPF computation provides the one or more paths with the one or more regen nodes in the defined order.

3. The apparatus of claim 1, wherein the discourage factor is used to increase cost of all links except those in the inclusion hops list, thereby placing such links in the inclusion hops list at a top of the tent list.

4. The apparatus of claim 1, wherein the SPF computation is a k-SPF computation to obtain k paths, k>1, for the one or more paths.

5. The apparatus of claim 1, wherein the performing the SPF computation further includes allocating spectrum between the source node, the one or more regen nodes, and the destination node.

6. The apparatus of claim 5, wherein the spectrum allocation includes a change in spectrum along a path.

7. The apparatus of claim 1, wherein the apparatus is located at a network element in the optical network.

8. A non-transitory computer-readable medium storing instructions that, when executed, cause one or more processors to implement steps of:
receiving a request to compute one or more paths from a source node to a destination node with one or more regen nodes in an optical network;
utilizing the one or more regen nodes as an inclusion hops list; and
performing a Shortest Path First (SPF) computation with the inclusion hops list to find the one or more paths with tentative (tent) paths maintained in a tent list and further utilizing a discourage factor in minimal route diversity to order the tent paths in the tent list based on the inclusion hops list.

9. The non-transitory computer-readable medium of claim 8, wherein the inclusion hops list includes the one or more regen nodes in a defined order such that the SPF computation provides the one or more paths with the one or more regen nodes in the defined order.

10. The non-transitory computer-readable medium of claim 8, wherein the discourage factor is used to increase cost of all links except those in the inclusion hops list, thereby placing such links in the inclusion hops list at a top of the tent list.

11. The non-transitory computer-readable medium of claim 8, wherein the SPF computation is a k-SPF computation to obtain k paths, k>1, for the one or more paths.

12. The non-transitory computer-readable medium of claim 8, wherein the performing the SPF computation further includes allocating spectrum between the source node, the one or more regen nodes, and the destination node.

13. The non-transitory computer-readable medium of claim 12, wherein the spectrum allocation includes a change in spectrum along a path.

14. The non-transitory computer-readable medium of claim 8, wherein the one or more processors are in a network element in the optical network.

15. A method comprising steps of:
receiving a request to compute one or more paths from a source node to a destination node with one or more regen nodes in an optical network;
utilizing the one or more regen nodes as an inclusion hops list; and
performing a Shortest Path First (SPF) computation with the inclusion hops list to find the one or more paths with tentative (tent) paths maintained in a tent list and further utilizing a discourage factor in minimal route diversity to order the tent paths in the tent list based on the inclusion hops list.

16. The method of claim 15, wherein the inclusion hops list includes the one or more regen nodes in a defined order such that the SPF computation provides the one or more paths with the one or more regen nodes in the defined order.

17. The method of claim 15, wherein the discourage factor is used to increase cost of all links except those in the inclusion hops list, thereby placing such links in the inclusion hops list at a top of the tent list.

18. The method of claim 15, wherein the SPF computation is a k-SPF computation to obtain k paths, k>1, for the one or more paths.

19. The method of claim 15, wherein the performing the SPF computation further includes allocating spectrum between the source node, the one or more regen nodes, and the destination node.

20. The method of claim 15, wherein the method is performed by a network element in the optical network.
